(19) United States
(12) Patent Application Publication
(10) Pub. No.: US 2006/0109302 A1
(43) Pub. Date: May 25, 2006

(54) Inkjet printer

(75) Inventor: Karp-Sik Youn, Hwaseong-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/235,172

(22) Filed: Sep. 27, 2005

(30) Foreign Application Priority Data
Nov. 19, 2004 (KR) 2004-0095063

(51) Int. Cl. B41J 2/165

(52) U.S. Cl. 347/33

(57) ABSTRACT

An inkjet printer is provided. The inkjet printer includes a printing head comprising a nozzle unit having a length corresponding to a width of a printing medium. The printing head also has a cleaning device comprising a wiper removing ink remaining on an output section of the nozzle unit while the cleaning device moves in a perpendicular direction to a length direction of the printing head.

### CROSS-REFERENCE TO RELATED APPLICATIONS

This application claims the priority of Korean Patent Application No. 10-2004-0095063, filed on Nov. 19, 2004, the entire disclosure of which is hereby incorporated by reference.

### BACKGROUND OF THE INVENTION

1. Field of the Invention

The present invention relates to an inkjet printer. More particularly, the present invention relates to an inkjet printer capable of cleaning a nozzle unit that sprays ink.

2. Description of the Related Art

Generally, an inkjet printer is an apparatus that forms an image by spraying ink onto a printed medium, such as printing paper, using a printing head. The printing head separates from the printing paper by a predetermined distance and moves back and forth above the paper in a direction perpendicular to a paper feed direction. The printing head includes a nozzle unit including a plurality of nozzles which spray ink. After the ink is sprayed from a nozzle onto the printing medium, ink droplets often remain on an output section of the nozzle. With repeated spraying, the ink droplets become larger and may fall undesirably. Moreover, the ink droplets may absorb dust particles from the air and thus become a dry solid that may partially block the nozzle. In this case, the spray direction may be distorted, thereby forming an undesirable image. As a result, printing quality decreases.

To overcome the aforementioned problem, devices for wiping ink remaining on printing nozzles are disclosed in Japanese Patent Publication Nos. 2-113949, 5-092576, 11-254692, and 15-063021; the entire disclosures of which are hereby incorporated by reference. These conventional devices are implemented by moving a wiper, which is a little longer than a nozzle unit typically having a length of about 1 inch, in the width direction of the printing medium. The wiper is moved back and forth in a paper feed direction or moved one or two times in one direction. Consequently, the wiper contacts the nozzle unit and wipes off ink, such as in the form of droplets, solids, and dust particles.

Recently, instead of a printing head running back and forth perpendicularly to the printing medium feed direction, a printing head including a nozzle unit having a length corresponding to the width of the printing paper is used to accomplish high-speed printing. In this case, the printing head is almost stationary while the printing medium is fed. Accordingly, a driving system of an inkjet printer is simplified and high-speed printing is possible. However, it is difficult to clean such long nozzles with conventional wipers.

Therefore, there is a need for an improved wiper for cleaning a long printing head nozzle unit, such as a nozzle unit having a length of about 210 mm for A4 paper, which does not reciprocate.

### SUMMARY OF THE INVENTION

An aspect of the present invention is to solve at least the above problems and/or disadvantages and to provide at least the advantages described below. Accordingly, an aspect of the present invention is to provide an inkjet printer including a device for cleaning a printing head including a nozzle unit having a length corresponding to the width of a printing medium.

According to an aspect of the present invention, there is provided an inkjet printer including a printing head comprising a nozzle unit having a length corresponding to a width of a printing medium, and a cleaning device comprising a wiper which removes ink remaining on an output section of the nozzle unit while the cleaning device moves in a perpendicular direction to a length direction of the printing head.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a schematic perspective view of a an inkjet printer using a cleaning device according to an exemplary embodiment of the present invention;

FIG. 2 is a plan view of the cleaning device shown in FIG. 1;

FIG. 3 is a plan view of a cleaning device according to a second exemplary embodiment of the present invention;

FIG. 4 is a plan view of a cleaning device according to another exemplary embodiment of the present invention;

FIG. 5 is a plan view of a cleaning device according to another exemplary embodiment of the present invention;

FIG. 6 is a plan view of a cleaning device according to yet another exemplary embodiment of the present invention;

FIG. 7 is a plan view of a cleaning device according to still another exemplary embodiment of the present invention;

FIGS. 8 through 10 are plan views illustrating the operation of the cleaning device shown in FIG. 1 that cleans a printing head; and

FIG. 11 is a plan view of a cleaning device according to another exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

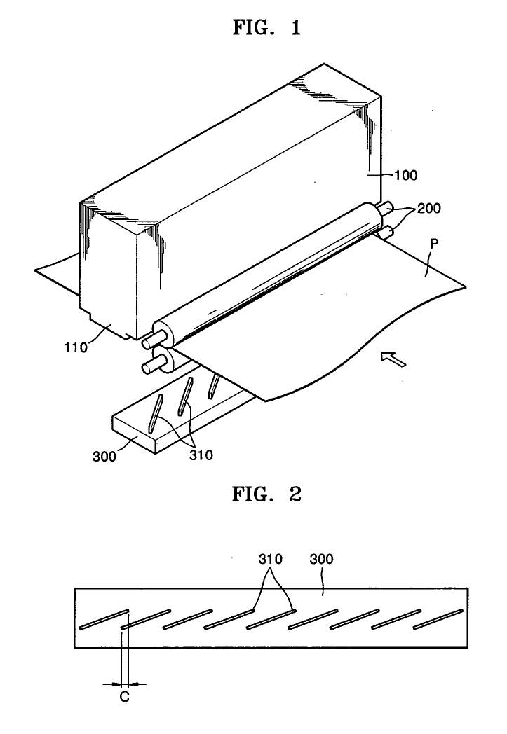

Referring to FIG. 1, an inkjet printer includes a printing head 100 provided with a nozzle unit 110 having a length corresponding to a width of a printing paper P, a pair of feed rollers 200 facing each other and rotating to feed the printing paper P passing therebetween toward the nozzle unit 110, and a cleaning device 300 installed below the printing head 100 to remove ink remaining on the nozzle unit 110.

The nozzle unit 110 includes a nozzle plate (not shown) provided with a plurality of nozzles (not shown) at predetermined intervals. The nozzle plate may be disposed in diverse ways and is not restricted to a particular disposition pattern.

Referring to FIG. 2, the cleaning device 300 according to a first exemplary embodiment of the present invention includes a plurality of wipers 310 protruding upward and aligned in a length direction of the cleaning device 300. Each of the wipers 310 is arranged obliquely such that each wiper 310 partially overlaps with an adjacent wiper 310 by a predetermined length C. In detail, an end portion of each wiper 310 overlaps with an end portion of an adjacent wiper 310. With such an arrangement, ink beyond the ends of each wiper 310 can be wiped off by the adjacent wiper 310 so that residual ink can be completely removed from the nozzle unit 110.

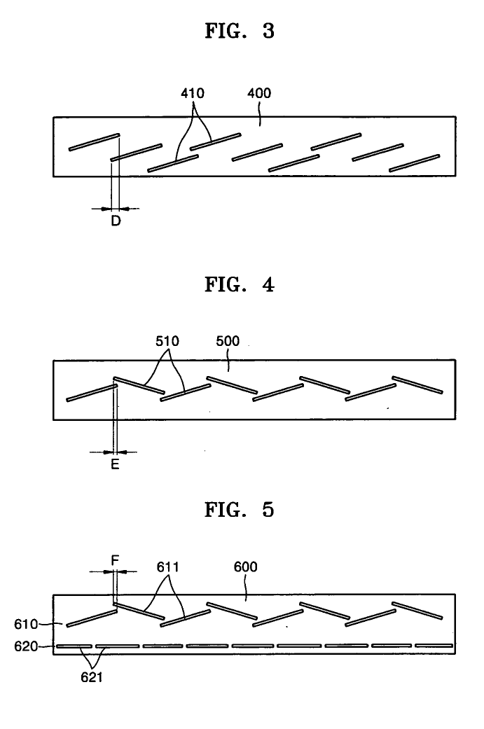

Referring to FIG. 3, a cleaning device 400 according to a second exemplary embodiment of the present invention includes a plurality of wipers 410 protruding upward and arranged obliquely. The wipers 410 are disposed in a plurality of rows along a length direction of the cleaning device 400. Wipers 410 in a subsequent row are disposed such that a first wiper 410 in the subsequent row is positioned between second and third wipers 410 in a previous row and the other wipers 410 in the subsequent row are positioned in the same manner. Each wiper 410 overlaps with an adjacent wiper 410 in other rows by a predetermined length D. In detail, an end portion of each wiper 410 overlaps with an end portion of an adjacent wiper 410.

Referring to FIG. 4, a cleaning device 500 according to a third exemplary embodiment of the present invention includes a plurality of wipers 510 protruding upward and arranged obliquely. The wipers 510 are disposed in a zigzag pattern in a line along a length direction of the cleaning device 500. Each wiper 510 overlaps with an adjacent wiper 510 by a predetermined length E.

Referring to FIG. 5, a cleaning device 600 according to a fourth exemplary embodiment of the present invention includes a first wiper group 610 and a second wiper group 620. The first wiper group 610 includes a plurality of wipers 610 protruding upward at an upper portion of a top surface of the cleaning device 600. The wipers 610 are disposed in a zigzag pattern in a line along a length direction of the cleaning device 600. The second wiper group 620 includes a plurality of wipers 621 protruding upward in a lower portion of the top surface of the cleaning device 600. The wipers 621 are aligned at predetermined intervals along the length direction of the cleaning device 600.

Each of the wipers 611 in the first wiper group 610 are disposed to overlap with an adjacent wiper 611 by a predetermined length F. It is preferable that an overlap between adjacent wipers 611 in the first wiper group 610 is not on the same vertical line as an interval between adjacent wipers 621 in the second wiper group 620. With such arrangement, the first wiper group 610 initially wipes the nozzle unit 110 and then the second wiper group 620 wipes the nozzle unit 110 again. Accordingly, ink remaining on the nozzle unit 110 can be more completely removed.

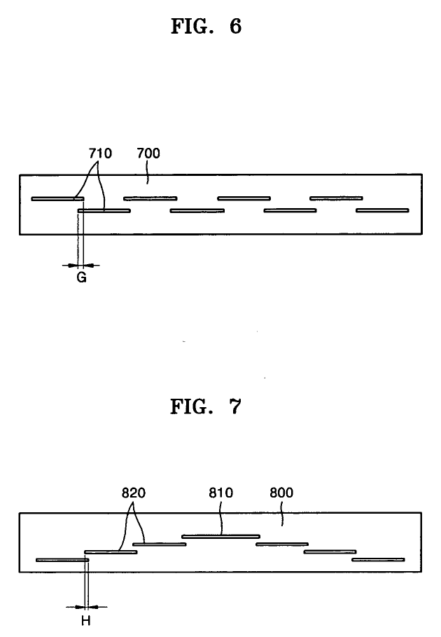

Referring to FIG. 6, a cleaning device 700 according to a fifth exemplary embodiment of the present invention includes a plurality of wipers 710 protruding upward. The wipers 710 are disposed alternately and parallel with each other in two rows along a length direction of the cleaning device 700. Each of the wipers 710 overlaps with an adjacent wiper 710 in a different row by a predetermined length G.

Referring to FIG. 7, a cleaning device 800 according to a sixth exemplary embodiment of the present invention includes a single wiper 810 and a plurality of wipers 820 protruding upward. The wiper 810 is disposed at a center of the cleaning device 800 and the wipers 820 are disposed in a step pattern, symmetric with respect to the wiper 810. The wiper 810 overlaps with adjacent wipers 820 and each of the wipers 820 overlaps with an adjacent wiper 820 by a predetermined length H.

As described above, instead of disposing a long single wiper along the length direction of a cleaning device, a plurality of wipers are disposed in various patterns along the length direction to disperse a load of the cleaning device. In other words, a large load is needed to clean an entire nozzle unit with a single large wiper. However, when a plurality of small wipers are used, they partially and sequentially contact the nozzle unit, and therefore, the load is dispersed. In addition, when only a single wiper is used, the whole wiper must be replaced in case of partial damage or defect thereof. However, when a plurality of wipers are used, only a damaged or defective wipers need replacement, which is financially advantageous. The disposition pattern of wipers included in a cleaning device according to the exemplary embodiments of the present invention is not restricted to the above-described embodiments, and various modifications may be made thereto.

The following description concerns the operation of a cleaning device according to the exemplary embodiments of the present invention.

Referring back to FIG. 1, when a cleaning operation is not performed, the cleaning device 300 is located below the printing head 100 and separated from the nozzle unit 110 by a predetermined distance so that it does not obstruct feeding of the printing paper P by the feed roller 200.

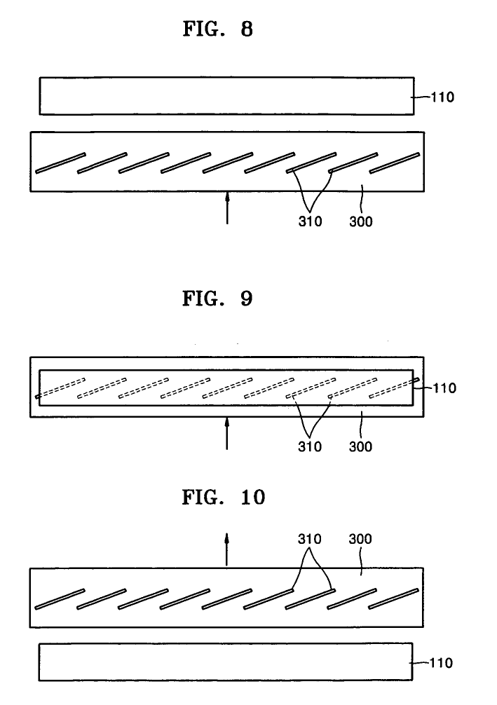

For the cleaning operation, referring to FIG. 8, the cleaning device 300 is moved towards the nozzle unit 110 in direction indicated by the arrow which the printing paper P is fed by the feed roller 200 shown in FIG. 1. Referring to FIGS. 9 and 10, the cleaning device 300 passes below the nozzle unit 110 so that the wipers 310 contact the nozzle unit 110 and wipes off ink remaining on the nozzle unit 110.

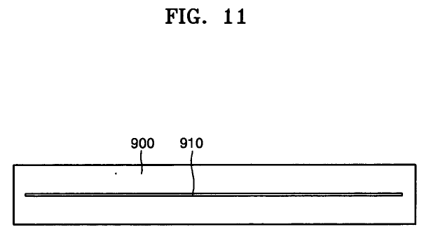

FIG. 11 is a plan view of a cleaning device 900 according to a seventh exemplary embodiment of the present invention. Unlike the cleaning devices described above, the cleaning device 900 includes a single wiper 910 protruding upward. The wiper 910 extends along in a length direction of the printing head 100 shown in FIG. 1. When the cleaning device 900 moves below the nozzle unit 1 10 in a perpendicular direction to the length direction of the printing head 100, the wiper 910 wipes off ink from the nozzle unit 110.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An inkjet printer comprising:
a printing head comprising a nozzle unit having a length corresponding to a width of a printing medium; and
a cleaning device comprising a wiper which removes ink remaining on an output section of the nozzle unit while the cleaning device moves in a direction perpendicular to a length direction of the printing head.

2. The inkjet printer of claim 1, wherein the cleaning device comprises a plurality of wipers.

3. The inkjet printer of claim 2, wherein the wipers are obliquely arranged in a single line.

4. The inkjet printer of claim 3, wherein each of the wipers overlaps with a portion of an adjacent wiper by a predetermined length.

5. The inkjet printer of claim 2, wherein the wipers are obliquely arranged in a plurality of rows, and each of the wipers overlaps with an adjacent wiper in a different row by a predetermined length.

6. The inkjet printer of claim 2, wherein the wipers are obliquely arranged in a zigzag pattern, and each of the wipers overlaps with an adjacent wiper by a predetermined length.

7. The inkjet printer of claim 2, wherein the wipers comprise:
a first wiper group in which wipers are obliquely, arranged in a zigzag pattern and each of the wipers overlaps with an adjacent wiper by a predetermined length; and
a second wiper group in which wipers are aligned at predetermined intervals along the length direction of the printing head.

8. The inkjet printer of claim 2, wherein the wipers are disposed alternately in at least two rows along the length direction of the printing head, and each of the wipers overlaps with an adjacent wiper by a predetermined length.

9. The inkjet printer of claim 2, wherein the wipers are disposed in a step pattern to be symmetric with respect to a center of the cleaning device, and each of the wipers overlaps with an adjacent wiper by a predetermined length.

10. The inkjet printer of claim 1, wherein the wiper extends long along the length direction of the printing head.

11. The inkjet printer of claim 2, wherein the wipers are obliquely arranged in at least two rows, and a first wiper of each subsequent row overlaps with an adjacent previous row between a second and third wiper by a predetermined length.

12. An inkjet printer comprising:
a printing head comprising a nozzle unit having a length corresponding to a width of a printing medium; and
a plurality of wipers arranged on a cleaning device which removes ink remaining on an output section of the nozzle unit while the cleaning device moves in a direction perpendicular to a length direction of the printing head;
wherein the wipers are obliquely arranged in a plurality of rows, and each of the wipers overlaps with an adjacent wiper by a predetermined length.
